(19) United States
(12) Patent Application Publication
(10) Pub. No.: US 2022/0154519 A1
(43) Pub. Date: May 19, 2022

(54) SAFE DOOR WITH IMPROVED BOLT MECHANISM AND AUTOMATED TRANSACTION MACHINE WITH THE SAME

(71) Applicant: Diebold Nixdorf, Incorporated, North Canton, OH (US)

(72) Inventor: Mark A. Douglass, North Canton, OH (US)

(21) Appl. No.: 17/528,833

(22) Filed: Nov. 17, 2021

Related U.S. Application Data
(60) Provisional application No. 63/114,696, filed on Nov. 17, 2020.

(51) Int. Cl. E05G 1/10; E05G 1/04; E05C 1/06; E05B 65/00

(52) U.S. Cl. CPC E05G 1/10; E05B 65/0075; E05C 1/06; E05G 1/04

(57) ABSTRACT

A mechanism for actuating a boltwork sensing switch in an Automated Transaction Machine (ATM) includes linear actuators that are rigidly affixed to a bracket. The actuators are operable to linearly move the bracket in synchronized linear movement with the actuators. In operation, as the actuators move the bracket, a distal end of the bracket will come into contact with a switch, causing the switch to change its binary status from either open to closed or closed to open. The signal from the switch, which indicates whether the main bolt is open or closed, is detected by a main processor of an Automated Transaction Machine.

### CROSS-REFERENCE TO RELATED APPLICATIONS

This application claims priority to and the benefit of U.S. Provisional Patent Application 63/114,696, Filed 17 Nov. 2020, the contents of which are hereby incorporated by reference in their entirety.

### BACKGROUND

This relates in general to Automated Transaction Machines (ATMs) and systems for automated financial or commercial transactions, sometimes known as an Automated Banking Machine or Automated Teller Machine.

ATMs are commonly used to carry out a variety of financial or commercial transactions. Most commonly, these transactions include dispensing cash, checking account balances, paying bills and/or receiving deposits from users. ATMs may also perform a variety of other transactions, including the sale and purchase of tickets, issuance of coupons, check or voucher presentation, the printing of script and a variety of other functions.

For carrying out these transactions or performing these functions, ATMs typically include a variety of components, and these components are chosen based upon what is necessary to include for the particular design and build of a particular production line or model of machine. Because the transactions include items of significant value, security and safekeeping of the documents, currency, and other materials is critical. Thus, a significant portion of the components in an ATM serve to provide security and safekeeping for the documents inside. The general portion of an ATM related to this security is a safe, and a substantial part of the safe's functionality is a door. The safe's door is secured by a bolt and a lock, along with emergency locking devices in the event of a break-in. Also, a processor is used to control various document transport systems within the ATM, monitor the status of the ATM (the safe in particular), and to communicate with financial institutions. The processor relies on electrical signals from switches and sensors associated with the safe to monitor its status. The status of the position of the bolt (e.g. whether it is open or closed) is a very important electrical signal for the processor to monitor, as it indicates whether the door is open.

Switching mechanisms for such bolts and locks are generally known. In one known configuration, lock actuators are affixed to and linearly move a bracket, which is connected to a lever at a pivot point. The pivot point may include a fastener, such as a screw or a rivet that acts to engage the lever to the bracket, but also allow rotation between the lever and the bracket. Motion may cause the lever to move in a rotational manner around a standoff. The standoff may be a cylindrical column that is welded to a frame that serves as a substrate for the actuators and a switch. In one operation, as the lever rotates, proportional to linear travel of actuators, a distal end of the lever will come into contact with the switch, causing the switch to change its binary status from either open to closed. A signal from the switch, which indicates whether the main bolt is open or closed, is detected by a main processor for the ATM.

### SUMMARY

This application relates in general to bolt mechanisms implemented in the door portion of a safe of an Automatic Teller Machines (ATM).

This relates more particularly to an improved boltwork switch for indicating the status of the boltwork.

In one embodiment, a bolt mechanism for a safe can include a base plate and a first electric switch, with the first electric switch having a first actuator arm. The bolt mechanism can further include a locking plate assembly and a cover plate, where the cover plate can be fixedly attached to the base plate assembly, and where the locking plate assembly can be displaceable along a first axis. The locking plate can have an open position and a closed position. The first electric switch can be mounted on the cover plate. The bolt mechanism can further include a first lock bolt bracket, where the first lock bolt bracket can be operatively attached to the locking plate assembly and can be concurrently displaced with the locking plate assembly along the first axis. The first lock bolt bracket can be positioned to be able to make contact with the first actuator arm and can thereby change the status of the first electric switch. The base plate assembly and the cover plate can be stationary relative to the displacement of the locking plate assembly. Displacement of the locking plate assembly from the open position to the closed position can cause the first lock bolt bracket to contact the first actuator arm on the first electric switch and can thereby change the status of the first electric switch.

In an additional embodiment, displacement of the locking plate assembly from the closed position to the open position causes the first bracket to no longer contact the first actuator arm on the first electric switch, thereby changing the status of the first electric switch.

In an additional embodiment, the locking plate assembly can be disposed between the base plate and the cover plate.

In an additional embodiment, at least a portion of the first lock bolt bracket can extend below the surface of the cover plate.

In an additional embodiment, a portion of the locking plate assembly can extend above the surface of the cover plate.

In an additional embodiment, the bolt mechanism can further include a first vertical bolt bar, wherein the first vertical bolt bar can operatively connected to the locking plate such that a displacement of the locking plate along a first axis produces a displacement of the first vertical bolt bar along a second axis, the second axis being perpendicular to the first axis.

Various aspects will become apparent to those skilled in the art from the following detailed description and the accompanying drawings.

### BRIEF DESCRIPTION OF THE DRAWINGS

FIG. 0 is a schematic representation of a bolt mechanism for a safe door for an automated transaction machine.

FIG. 1 is a schematic diagram of an ATM according to one embodiment;

FIG. 2 is a front view of a first embodiment of a bolt mechanism as used in the safe of the ATM in FIG. 1;

FIG. 3a is a right-side view of the first embodiment of the bolt mechanism in FIG. 2;

FIG. 3b is a left-side view of the first embodiment of the bolt mechanism in FIG. 2;

FIG. 4a is a top view of the first embodiment of the bolt mechanism in FIG. 2;

FIG. 4b is a bottom view of the first embodiment of the bolt mechanism in FIG. 2;

FIG. 5 is a cutaway view along B-B of the first embodiment of the bolt mechanism in FIG. 2;

FIG. 6 is a front perspective view of the first embodiment of the bolt mechanism in FIG. 2;

FIG. 7 is a rear perspective view of the first embodiment of the bolt mechanism in FIG. 2;

FIG. 7b is a perspective view of an exemplary embodiment of a cover plate;

FIG. 8 is a front view of a second embodiment of a bolt mechanism as used in the safe of the ATM in FIG. 1;

FIG. 9a is a right-side view of the second embodiment of the bolt mechanism in FIG. 8;

FIG. 9b is a left-side view of the second embodiment of the bolt mechanism in FIG. 8;

FIG. 10a is a top view of the second embodiment of the bolt mechanism in FIG. 8;

FIG. 10b is a bottom view of the second embodiment of the bolt mechanism in FIG. 8;

FIG. 11 is a detailed view of the left-side view of the bolt mechanism in FIG. 9b;

FIG. 12 is a cutaway view along B-B of the top view of the bolt mechanism in FIG. 10a;

FIG. 13 is a front view of the second embodiment of the bolt mechanism in FIG. 8 with the top plate and locking plate removed;

FIG. 14a is a side view of a base plate used in the first embodiment of the bolt mechanism in FIG. 2 and the second embodiment of the bolt mechanism in FIG. 8;

FIG. 14b is a side view of a base plate used in the first embodiment of the bolt mechanism in FIG. 2 and the second embodiment of the bolt mechanism in FIG. 8;

FIG. 14c is a perspective view of the base plate used in the first embodiment of the bolt mechanism in FIG. 2 and the second embodiment of the bolt mechanism in FIG. 8;

FIG. 15a is a side view of a locking plate used in the first embodiment of the bolt mechanism in FIG. 2 and the second embodiment of the bolt mechanism in FIG. 8;

FIG. 15b is a front view of the locking plate used in the first embodiment of the bolt mechanism in FIG. 2 and the second embodiment of the bolt mechanism in FIG. 8;

FIG. 16a is a front view of a vertical bolt bar assembly used in the first embodiment of the bolt mechanism in FIG. 2 and the second embodiment of the bolt mechanism in FIG. 8;

FIG. 16b is a side view of a vertical bolt bar assembly used in the first embodiment of the bolt mechanism in FIG. 2 and the second embodiment of the bolt mechanism in FIG. 8;

FIG. 17a is a front view of a cover plate used in the first embodiment of the bolt mechanism in FIG. 2 and the second embodiment of the bolt mechanism in FIG. 8;

FIG. 17b is a perspective view of the cover plate used in the first embodiment of the bolt mechanism in FIG. 2 and the second embodiment of the bolt mechanism in FIG. 8;

FIG. 17c is a left view of the cover plate used in the first embodiment of the bolt mechanism in FIG. 2 and the second embodiment of the bolt mechanism in FIG. 8;

FIG. 17d is a right view of the cover plate used in the first embodiment of the bolt mechanism in FIG. 2 and the second embodiment of the bolt mechanism in FIG. 8;

FIG. 17e is a bottom view of the cover plate used in the first embodiment of the bolt mechanism in FIG. 2 and the second embodiment of the bolt mechanism in FIG. 8;

FIG. 18 is a perspective view of a pressure spring used in the first embodiment of the bolt mechanism in FIG. 2 and the second embodiment of the bolt mechanism in FIG. 8;

FIG. 19a is a front view of a first washer used in the first embodiment of the bolt mechanism in FIG. 2 and the second embodiment of the bolt mechanism in FIG. 8;

FIG. 19b is a side view of the first washer used in the first embodiment of the bolt mechanism in FIG. 2 and the second embodiment of the bolt mechanism in FIG. 8;

FIG. 20a is a top view of a round lock bolt used in the first embodiment of the bolt mechanism in FIG. 2 and the second embodiment of the bolt mechanism in FIG. 8;

FIG. 20b is a cutaway view of the round lock bolt used in the first embodiment of the bolt mechanism in FIG. 2 and the second embodiment of the bolt mechanism in FIG. 8;

FIG. 20c is a side view of the round lock bolt used in the first embodiment of the bolt mechanism in FIG. 2 and the second embodiment of the bolt mechanism in FIG. 8;

FIG. 20d is a perspective view of the round lock bolt used in the first embodiment of the bolt mechanism in FIG. 2 and the second embodiment of the bolt mechanism in FIG. 8;

FIG. 21a is a front view of a switch mounting bracket used in the first embodiment of the bolt mechanism in FIG. 2 and the second embodiment of the bolt mechanism in FIG. 8;

FIG. 21b is a top view of the switch mounting bracket used in the first embodiment of the bolt mechanism in FIG. 2 and the second embodiment of the bolt mechanism in FIG. 8;

FIG. 21c is a side view of the switch mounting bracket used in the first embodiment of the bolt mechanism in FIG. 2 and the second embodiment of the bolt mechanism in FIG. 8;

FIG. 22a is a front view of a relocker pin used in the first embodiment of the bolt mechanism in FIG. 2 and the second embodiment of the bolt mechanism in FIG. 8;

FIG. 22b is a top view of the relocker pin used in the first embodiment of the bolt mechanism in FIG. 2 and the second embodiment of the bolt mechanism in FIG. 8;

FIG. 22c is a side view of the relocker pin used in the first embodiment of the bolt mechanism in FIG. 2 and the second embodiment of the bolt mechanism in FIG. 8;

FIG. 23a is a front view of a relocker cover plate used in the first embodiment of the bolt mechanism in FIG. 2 and the second embodiment of the bolt mechanism in FIG. 8;

FIG. 23b is a side view of the relocker cover plate used in the first embodiment of the bolt mechanism in FIG. 2 and the second embodiment of the bolt mechanism in FIG. 8

FIG. 24a is a front view of a washer used in the first embodiment of the bolt mechanism in FIG. 2 and the second embodiment of the bolt mechanism in FIG. 8;

FIG. 24b is a side view of the washer used in the first embodiment of the bolt mechanism in FIG. 2 and the second embodiment of the bolt mechanism in FIG. 8

FIG. 25a is a front view of a cam plate used in the first embodiment of the bolt mechanism in FIG. 2 and the second embodiment of the bolt mechanism in FIG. 8;

FIG. 25b is a bottom view of the cam plate used in the first embodiment of the bolt mechanism in FIG. 2 and the second embodiment of the bolt mechanism in FIG. 8;

FIG. 25c is a side view of the cam plate used in the first embodiment of the bolt mechanism in FIG. 2 and the second embodiment of the bolt mechanism in FIG. 8;

FIG. 25d is a perspective view of the cam plate used in the first embodiment of the bolt mechanism in FIG. 2 and the second embodiment of the bolt mechanism in FIG. 8;

FIG. 26a is a cutaway view of a spacer used in the first embodiment of the bolt mechanism in FIG. 2 and the second embodiment of the bolt mechanism in FIG. 8;

FIG. 26b is a front view of the spacer used in the first embodiment of the bolt mechanism in FIG. 2 and the second embodiment of the bolt mechanism in FIG. 8;

FIG. 27a is a front view of a small relocker used in the first embodiment of the bolt mechanism in FIG. 2 and the second embodiment of the bolt mechanism in FIG. 8;

FIG. 27b is a front view of the small relocker used in the first embodiment of the bolt mechanism in FIG. 2 and the second embodiment of the bolt mechanism in FIG. 8;

FIG. 28a is a side view of a large relocker used in the first embodiment of the bolt mechanism in FIG. 2 and the second embodiment of the bolt mechanism in FIG. 8;

FIG. 28b is a front view of the large relocker used in the first embodiment of the bolt mechanism in FIG. 2 and the second embodiment of the bolt mechanism in FIG. 8;

FIG. 29a is a side view of a relocker cylinder used in the first embodiment of the bolt mechanism in FIG. 2 and the second embodiment of the bolt mechanism in FIG. 8;

FIG. 29b is a top view of the relocker cylinder used in the first embodiment of the bolt mechanism in FIG. 2 and the second embodiment of the bolt mechanism in FIG. 8;

FIG. 30a is a side view of a lock retaining bracket used in the first embodiment of the bolt mechanism in FIG. 2 and the second embodiment of the bolt mechanism in FIG. 8;

FIG. 30b is a front view of the lock retaining bracket used in the first embodiment of the bolt mechanism in FIG. 2 and the second embodiment of the bolt mechanism in FIG. 8;

FIG. 30c is a perspective view of the lock retaining bracket used in the first embodiment of the bolt mechanism in FIG. 2 and the second embodiment of the bolt mechanism in FIG. 8;

FIG. 31a is a front view of a bottom lock bolt bracket used in the first embodiment of the bolt mechanism in FIG. 2 and the second embodiment of the bolt mechanism in FIG. 8;

FIG. 31b is a bottom view of the bottom lock bolt bracket used in the first embodiment of the bolt mechanism in FIG. 2 and the second embodiment of the bolt mechanism in FIG. 8;

FIG. 31c is a side view of the bottom lock bolt bracket used in the first embodiment of the bolt mechanism in FIG. 2 and the second embodiment of the bolt mechanism in FIG. 8;

FIG. 31d is a perspective view of the bottom lock bolt bracket used in the first embodiment of the bolt mechanism in FIG. 2 and the second embodiment of the bolt mechanism in FIG. 8;

FIG. 32a is a front view of a top lock bolt bracket used in the first embodiment of the bolt mechanism in FIG. 2 and the second embodiment of the bolt mechanism in FIG. 8;

FIG. 32b is a top view of the top lock bolt bracket used in the first embodiment of the bolt mechanism in FIG. 2 and the second embodiment of the bolt mechanism in FIG. 8;

FIG. 32c is a side view of the top lock bolt bracket used in the first embodiment of the bolt mechanism in FIG. 2 and the second embodiment of the bolt mechanism in FIG. 8;

FIG. 32d is a perspective view of the top lock bolt bracket used in the first embodiment of the bolt mechanism in FIG. 2 and the second embodiment of the bolt mechanism in FIG. 8;

FIG. 33a is a front view of a glass plate used in the first embodiment of the bolt mechanism in FIG. 2 and the second embodiment of the bolt mechanism in FIG. 8;

FIG. 33b is a side view of the glass plate used in the first embodiment of the bolt mechanism in FIG. 2 and the second embodiment of the bolt mechanism in FIG. 8;

FIG. 34a is a top view of a glass plate bushing used in the first embodiment of the bolt mechanism in FIG. 2 and the second embodiment of the bolt mechanism in FIG. 8;

FIG. 34b is a perspective view of the glass plate bushing used in the first embodiment of the bolt mechanism in FIG. 2 and the second embodiment of the bolt mechanism in FIG. 8;

FIG. 34c is a side view of the glass plate bushing used in the first embodiment of the bolt mechanism in FIG. 2 and the second embodiment of the bolt mechanism in FIG. 8;

FIG. 35a is a side view of a rubber bushing used in the first embodiment of the bolt mechanism in FIG. 2 and the second embodiment of the bolt mechanism in FIG. 8;

FIG. 35b is a front view of the rubber bushing used in the first embodiment of the bolt mechanism in FIG. 2 and the second embodiment of the bolt mechanism in FIG. 8;

FIG. 35c is a perspective view of the rubber bushing used in the first embodiment of the bolt mechanism in FIG. 2 and the second embodiment of the bolt mechanism in FIG. 8;

FIG. 36a is a side view of a handlebar used in the first embodiment of the bolt mechanism in FIG. 2;

FIG. 36b is a front view of the handlebar used in the first embodiment of the bolt mechanism in FIG. 2;

FIG. 36c is a perspective view of the handlebar used in the first embodiment of the bolt mechanism in FIG. 2;

FIG. 37a is an end view of the shaft used in the handlebar in FIGS. 36a-36c and in the first embodiment of the bolt mechanism in FIG. 2;

FIG. 37b is a side view of the shaft used in the handlebar in FIGS. 35a-35c and in the first embodiment of the bolt mechanism in FIG. 2;

FIG. 38a is a front view of the bushing used in the handlebar in FIGS. 35a-35c and in the first embodiment of the bolt mechanism in FIG. 2;

FIG. 38b is a side view of the bushing used in the handlebar in FIGS. 35a-35c and in the first embodiment of the bolt mechanism in FIG. 2;

FIG. 39a is a side view of a first pan head screw used in the first embodiment of the bolt mechanism in FIG. 2 and the second embodiment of the bolt mechanism in FIG. 8;

FIG. 39b is a front view of the first pan head screw used in the first embodiment of the bolt mechanism in FIG. 2 and the second embodiment of the bolt mechanism in FIG. 8;

FIG. 39c is a perspective view of the first pan head screw used in the first embodiment of the bolt mechanism in FIG. 2 and the second embodiment of the bolt mechanism in FIG. 8;

FIG. 40 is a perspective view of a tension spring used in the first embodiment of the bolt mechanism in FIG. 2 and the second embodiment of the bolt mechanism in FIG. 8;

FIG. 41a is a side view of a second washer used in the first embodiment of the bolt mechanism in FIG. 2 and the second embodiment of the bolt mechanism in FIG. 8;

FIG. 41b is a front view of the second washer used in the first embodiment of the bolt mechanism in FIG. 2 and the second embodiment of the bolt mechanism in FIG. 8;

FIG. 41c is a perspective view of the second washer used in the first embodiment of the bolt mechanism in FIG. 2 and the second embodiment of the bolt mechanism in FIG. 8;

FIG. 42a is a side view of a second pan head screw used in the first embodiment of the bolt mechanism in FIG. 2 and the second embodiment of the bolt mechanism in FIG. 8;

FIG. 42b is a front view of the second pan head screw used in the first embodiment of the bolt mechanism in FIG. 2 and the second embodiment of the bolt mechanism in FIG. 8;

FIG. 42c is a perspective view of the second pan head screw used in the first embodiment of the bolt mechanism in FIG. 2 and the second embodiment of the bolt mechanism in FIG. 8;

FIG. 43a is a side view of a third pan head screw used in the first embodiment of the bolt mechanism in FIG. 2 and the third embodiment of the bolt mechanism in FIG. 8;

FIG. 43b is a front view of the third pan head screw used in the first embodiment of the bolt mechanism in FIG. 2 and the third embodiment of the bolt mechanism in FIG. 8;

FIG. 43c is a perspective view of the third pan head screw used in the first embodiment of the bolt mechanism in FIG. 2 and the third embodiment of the bolt mechanism in FIG. 8;

FIG. 44a is a side view of a cheese head screw used in the first embodiment of the bolt mechanism in FIG. 2 and the fourth embodiment of the bolt mechanism in FIG. 8;

FIG. 44b is a front view of the cheese head screw used in the first embodiment of the bolt mechanism in FIG. 2 and the fourth embodiment of the bolt mechanism in FIG. 8;

FIG. 44c is a perspective view of the cheese head screw used in the first embodiment of the bolt mechanism in FIG. 2 and the fourth embodiment of the bolt mechanism in FIG. 8.

### DETAILED DESCRIPTION

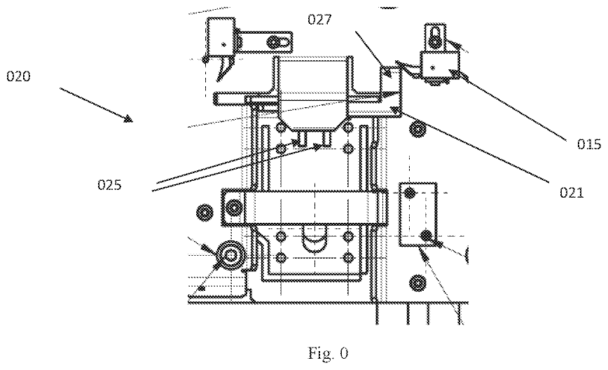

Referring now to the drawings, there is illustrated in FIG. 0 a bolt mechanism in accordance with one embodiment of the present invention, including a switching mechanism 020.

The switching mechanism includes linear actuators 025 that are rigidly affixed to a bracket 021. The actuators 025 are operable to linearly move bracket 021 in synchronized linear movement with the actuators 025. In operation, as the actuators 025 move the bracket 021, a distal end 027 of the bracket 021 will come into contact with a switch 015, causing the switch to change its binary status from either open to closed or closed to open. The signal from the switch 015, which indicates whether the main bolt is open or closed, is detected by a main processor of an Automated Transaction Machine.

The present disclosure, as demonstrated by the exemplary embodiment described below, can provide a more reliable and cost-effective bolt mechanism for an ATM. In an ATM, the safe can be desirable for secure storage of documents including cash, checks, or other notes of value. A bolt mechanism can be used to secure the door of the safe in the ATM, and the bolt mechanism can utilize one or more locks to secure the bolt mechanism. A computer can be used to control the various systems and functions of the ATM. It can be beneficial for the controlling computer of the ATM to have precise information about the status of the locks that are used to secure the bolt mechanism on the door of the safe.

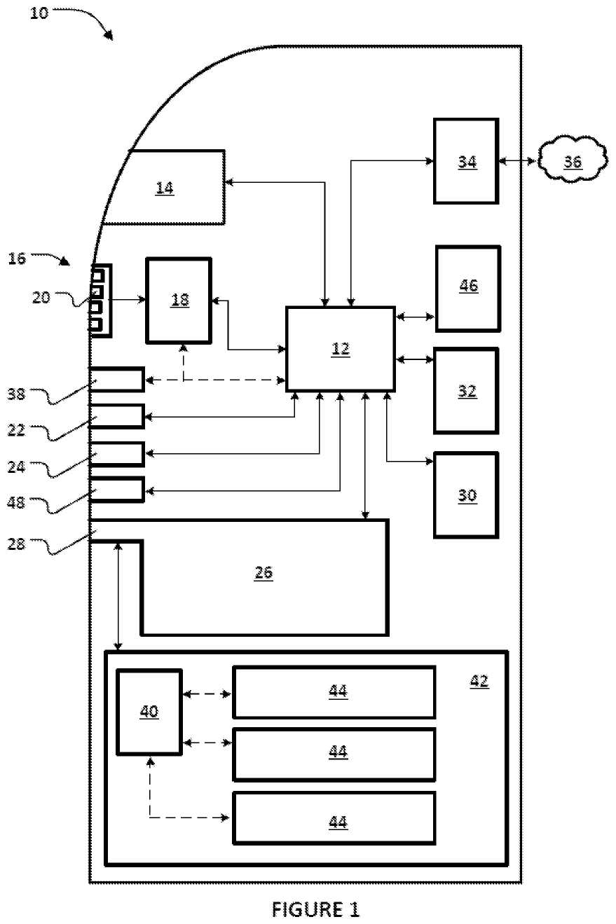

Referring now FIG. 1, there is disclosed a functional block diagram of an exemplary ATM 10 according to one or more implementations of the present disclosure. The ATM 10 includes different structures and subsystems for receiving input from a user and executing transactions. The ATM 10 includes a computing device 12. The exemplary computing device 12 has one or more processors and a non-transitory, computer readable medium. The computing device 12 operates under the control of an operating system, kernel and/or firmware and executes or otherwise relies upon various computer software applications, components, programs, objects, modules, data structures, etc. The exemplary computing device 12 can operate under the control of the Windows® operating system. The computer readable medium (memory) of the computing device 12 can include random access memory (RAM) devices comprising the main storage of computing device 12, as well as any supplemental levels of memory, e.g., cache memories, non-volatile or backup memories (e.g., programmable or flash memories), read-only memories, etc. In addition, the memory may be considered to include memory storage physically located elsewhere from RAM in the computing device 12, such as any cache memory in a processor, as well as any storage capacity used as a virtual memory. The computing device 12 can also include one or more mass storage devices, e.g., a floppy or other removable disk drive, a hard disk drive, a direct access storage device (DASD), an optical drive (e.g., a CD drive, a DVD drive, etc.), and/or a tape drive, among others, represented by memory 46.

The exemplary ATM 10 also includes a display 14. The computing device 12 can control the display 14 to present information to the user for furthering completion of the transaction. The display 14 can be a touch screen that allows the user to enter information through the display 14. The exemplary display 14 is configured to transmit any user-entered information to the computing device 12.

The exemplary ATM 10 also includes a key pad 16 and an encryption module 18. Generally, the combination of a key pad and an encryption module are referred to in the art as an encrypted pin pad (EPP). The exemplary key pad 16 includes a plurality of keys, such as key 20. The exemplary encryption module 18 has one or more processors and a non-transitory, computer readable medium. The user can press the keys of the key pad 16 to enter a Personal Identification Number (PIN). The key pad 16 is placed in communication with the encryption module 18 and therefore the numbers of the PIN are received by the encryption module 18. It is noted that the communication of the PIN is direct and secure; the PIN cannot be intercepted between the key pad 16 and the encryption module 18. The PIN is then encrypted by the encryption module 18 to define a PIN block. The encryption module 18 includes a network encryption key and applies the network encryption key to encrypt the PIN to the PIN block. The exemplary encryption module 18 is configured to transmit the PIN block to the computing device 12, which can direct the PIN block away from the ATM 10 during the completion of a financial transaction.

The exemplary ATM 10 also includes a card reader 22. The card reader 22 can receive a token from the user, such as a card. The card reader 22 can be configured to execute read and write operations with respect to any storage medium fixed to the user's card. The exemplary card reader 22 can be configured to read data from a magnetic strip on the back of a card or a chip embedded in the card. The exemplary card reader 22 can be configured to transmit any data read from the user's card to the computing device 12, which can direct the data read from the card away from the ATM 10 during completion of a financial transaction. The exemplary card reader 22 can also be configured to receive commands and data from the computing device 12 and change data stored on the user's card.

The exemplary ATM 10 also includes a printer module 24. The computing device 12 can control the printer module 24 to print a receipt when a transaction has been completed. The printer module 24 can communicate one or more messages to the computing device 12, such as a maintenance message regarding the need to refill printer paper.

The exemplary ATM 10 also includes an article exchange unit 26. In the exemplary embodiment, the article exchange unit 26 is configured to receive items such as checks. An exemplary article exchange unit 26 can include a drum on which received items are stored. The exemplary article exchange unit 26 includes a slot 28 open to an exterior of the ATM 10 for the receipt of such items. In other embodiments of the present disclosure, an article exchange unit can be configured to facilitate the receipt of other items, different than paper. The article exchange unit 26 can include one or more sensors and transmit signals from any such sensors to the computing device 12 to execute an exchange. The computing device 12 can control the article exchange unit 26 in response to such signals. For example, the article exchange unit 26 can include a sensor that detects receipt of an item such as a check. The article exchange unit 26 can include a further sensor in the form of a scanner that generates an image of the received item and transmits the image to the computing device 12. When an exchange involves the dispensation of an article to the user, the computing device 12 can control the article exchange unit 26 to dispense the item(s) requested by the user.

The exemplary ATM 10 also includes a printer module 30. The printer module 30 can generate a continuous record of all transactions executed by the ATM 10. The computing device 12 can control the printer module 30 to supplement the record after each transaction has been completed. The printer module 30 can communicate one or more messages to the computing device 12, such as a maintenance message regarding the need to refill printer paper.

The exemplary ATM 10 also includes an access module 32. The access module 32 can be positioned proximate to a rear side of the ATM 10. The access module 32 can be utilized by service and support technicians. For example, the access module 32 can be utilized by a field engineer to complete software updates to the computing device 12. The access module 32 can also be utilized when non-software updates and maintenance is performed, such as the refilling of printer paper or currency.

The exemplary ATM 10 also includes a transceiver 34. The exemplary transceiver 34 is configured to facilitate communication between the computing device 12 and other computing devices that are distinct from and physically remote from the computing device 12. An example of such a remote computing device is a server computing device, such as a banking or financial institution server communicating with a plurality of ATMs. The exemplary transceiver 34 places the computing device 12 in communication with one or more networks, such as network 36. The network 36 can be a local area network (LAN), a wide area network (WAN) such as the Internet, a Multi-protocol label switching (MPLS) network, a cellular network such as operated by cellular phone companies, or any combination thereof. The network 36 can be a financial/bank network such as NYCE, PULSE, PLUS, Cirrus, AFFN, Interac, Interswitch, STAR, LINK, MegaLink, or BancNet. The transceiver 34 can transmit data and requests for input generated by the computing device 12 and receive responses to these requests, directing these responses to the computing device 12.

The exemplary ATM 10 also includes a transceiver 38. The exemplary transceiver 38 is configured to facilitate communication between one of the encryption module 18 and the computing device 12 and other computing devices that are distinct from and physically proximate to the ATM 10. An example of such a proximate computing device is a smartphone possessed by the user. The dashed connection lines in FIG. 1 represent optional interconnections. The exemplary transceiver 38 can place the user's smartphone in communication with the encryption module 18, the computing device 12, or both. The exemplary transceiver 38 can implement various communication protocols. For example, the transceiver 38 can be a Near Field Communication (NFC) device. Alternatively, the transceiver 38 can be a Bluetooth beacon. The transceiver 38 can transmit and receive data and requests for input generated by the encryption module 18 and/or the computing device 12, such transmissions occurring with the user's smart phone for example.

The exemplary ATM 10 also includes an advanced function dispenser (AFD) 40. The AFD 40 can dispense banknotes, such as currency. The exemplary AFD 40 is positioned in a safe 42. One or more cassettes or cash boxes 44 are also positioned and protected in the safe 42. Banknotes are stored in the cassettes 44 for disbursement to a user of the ATM 10. The exemplary AFD 40 can extract the banknotes from one or more of the cassettes 44 and direct them out of the ATM 10 through the slot 28. The AFD 40 thus communicates with the slot 28 in parallel with the article exchange unit 26. The exemplary AFD 40 can communicate with and be controlled by the computing device 12 for at least some operations. Each of the cassettes 44 can engage the AFD 40 through a rack whereby the positioning of the cassettes is controlled. Further, the each of the cassettes 44 and the AFD 40 can include mating connectors of any form, whereby a positive interconnection is confirmed electronically. When one or more of the cassettes 44 and the AFD 40 are not properly interconnected, a signal or lack thereof can be communicated to the computing device 12 whereby an error message is generated or the ATM 10 can be disabled.

The exemplary ATM 10 also includes a scanner 48. The scanner 48 can scan, for example, at least a portion of a display of a smart phone and communicate the scanned display to the computing device 12. A token can be displayed on the display of the smart phone and thus scanned by the scanner 48. The token can be a bar code, a quick response (QR) code, a number, a string of alphanumeric characters, a weblink, or some other symbolic indicia. The exemplary scanner 48 is configured to transmit any scanned data to the computing device 12, which can direct the scanned away from the ATM 10 during completion of a financial transaction.

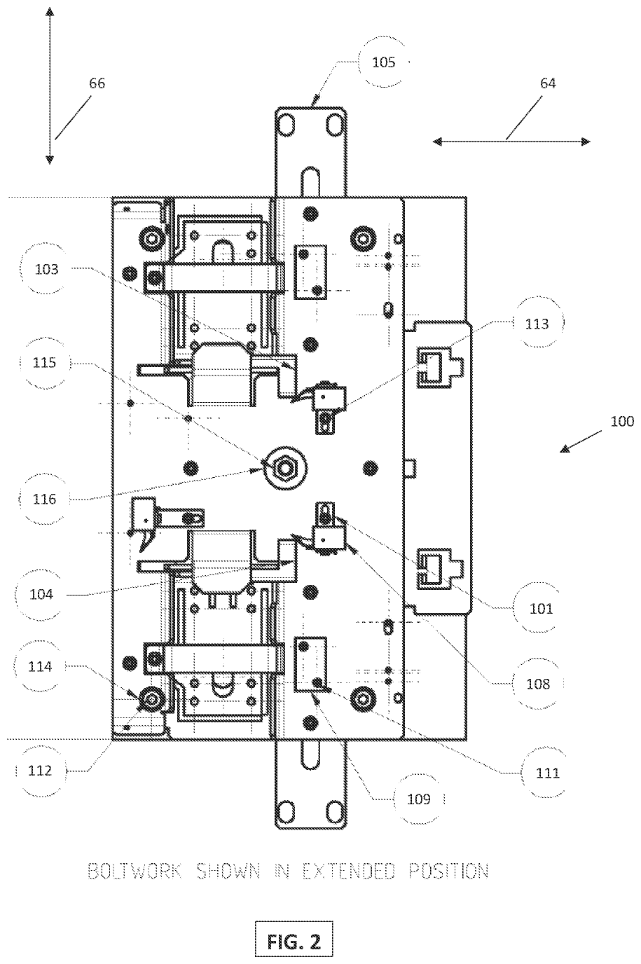

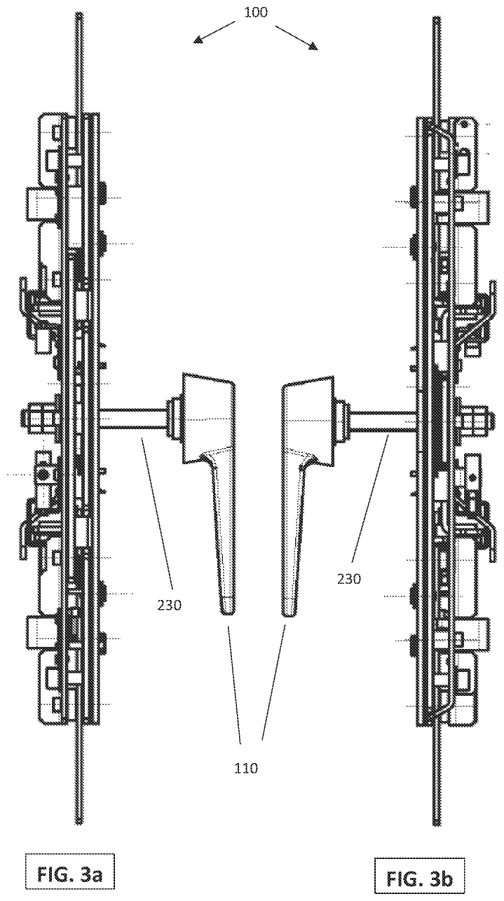

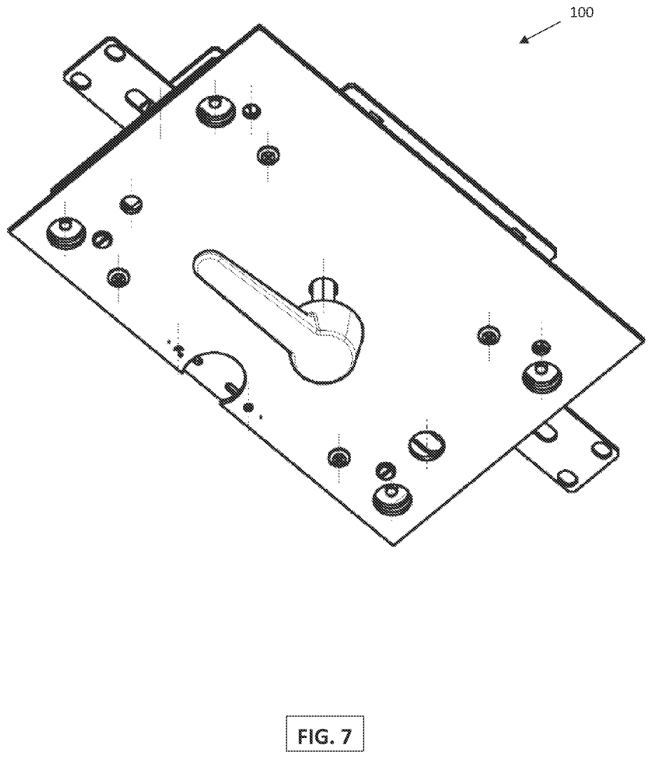

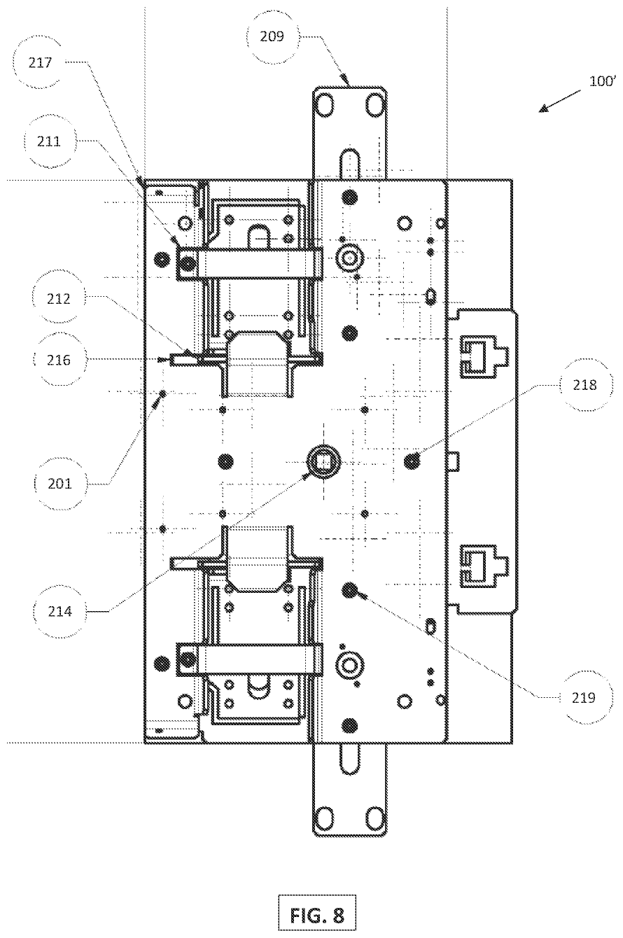

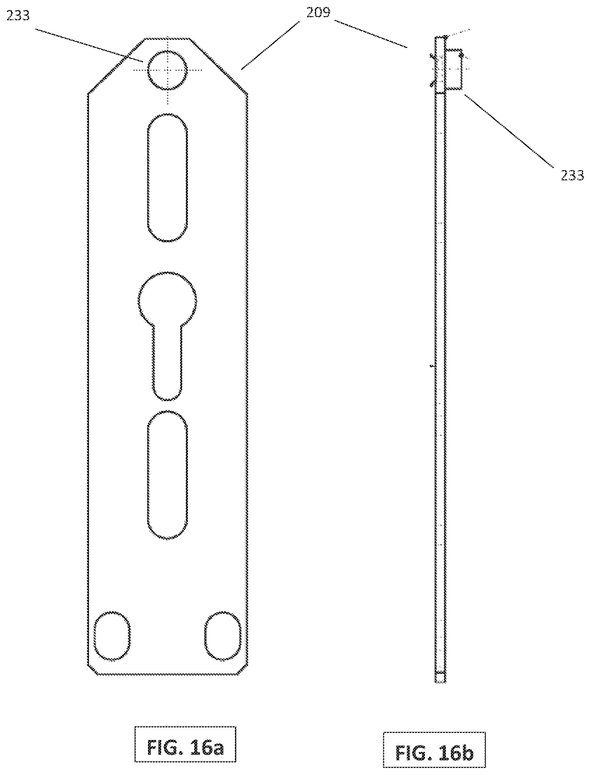

FIG. 2 is a front view of a first embodiment of a bolt mechanism 100 which can be used to secure safe 42. A cover plate 217 as seen in FIG. 8 can be mounted over base plate 216 and can have first electric switch 108 mounted thereon. First vertical bolt bar assembly 209 extends away from top and bottom of cover plate 217. The locking plate assembly 212 can be displaced along axis 64 by a user turning handlebar 110 as seen in FIG. 3a and FIG. 3b. Handlebar 110 can be connected to shaft 230 by bushing 231 and can be operatively connected to cam plate 214. Cam plate 214 can be operatively connected to locking plate assembly 212 with washer 215 positioned between them to reduce friction during movement. Vertical bolt bar assemblies 209 can have an attached guide bolt 233 as seen in FIGS. 16 and 16a, and guide bolt 233 can fit into angled slot 232 on locking plate assembly 212. Thus when locking plate assembly 212 can be displaced along horizontal axis 64, a vertical motion along vertical axis 66 can occur for the vertical bolt bar assembly 209.

Top lock bolt bracket 103 and bottom lock bolt bracket 104 can be attached to locking plate assembly 212 by fasteners, e.g. pan head screws. Top lock bolt bracket 103 and bottom lock bolt bracket 104 can be operatively attached to a top lock (not shown) and a bottom lock (not shown). A portion of locking plate assembly 212 can extend upward and provide screw holes for attaching to bolt brackets 103 and 104. Slots in cover plate 217 can allow for travel of the bolt brackets 103 and 104.

When locking plate assembly 212 is displaced along axis 64 by rotation of handlebar 110, bolt brackets 103 and 104 can move concurrently with the locking plate assembly along axis 64. When locking plate assembly 212 has reached a “closed” position, meaning that the safe is locked, the bolt brackets 103 and 104 can make contact with actuator arms on the switches 108, thus changing the status of the switches. Switches 108 can be mounted on switch mounting brackets 101 and can be secured by pan head screws 113. This change in status can be detected by computing device 12, and can thus provide confirmation that the bolt mechanism is in the locked position.

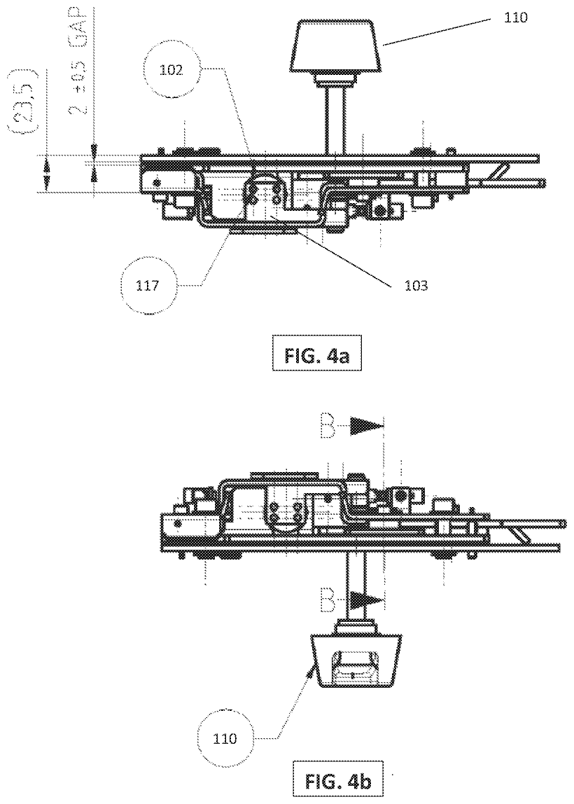

FIG. 4a shows round lock bolt 102 and top lock bolt bracket 103, which can be fastened with pan head screw 117. When handlebar 110 is subsequently turned by a user to open the safe, the locking plate can be displaced along the first axis in the opposite direction, and thus the bolt brackets 103 and 104 can move in the same direction. When the bolt brackets move away from the switch 108, they can disengage with the actuator, and the status of the switch can change appropriately.

FIG. 13 shows the embodiment of bolt mechanism 100′ from FIG. 8 with cover plate 217 and locking plate assembly 212 removed for viewing of the components. Vertical bolt bar assemblies 209 can be held in place by spacers 205, and washer 207 can be positioned over guide bolt 233 and can provide a reduction in friction between vertical bolt bars 209 and locking plate assembly 212.

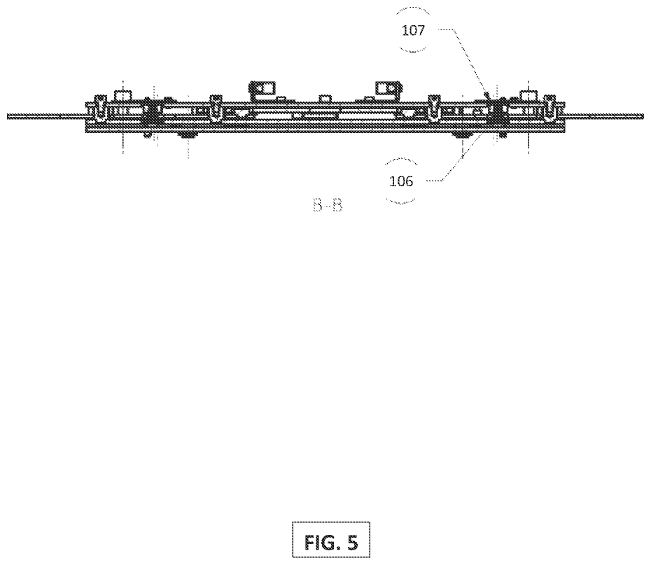

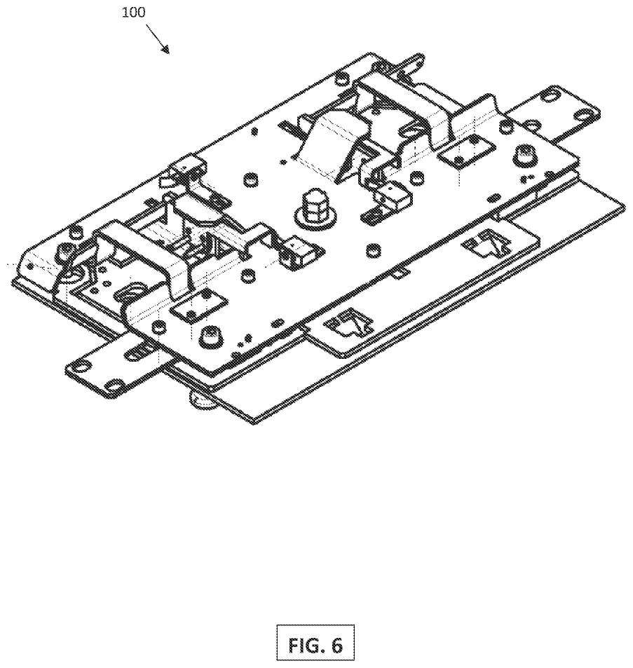

Components in the table below can be used in the first embodiment of bolt mechanism 100 shown in FIG. 2 through FIG. 7. Some or all of the components in the table can be used in other embodiments.

| Number | Part | Qty |
|---|---|---|
| 101 | switch mounting bracket | 3 |
| 102 | round lock bolt | 2 |
| 103 | top lock bolt bracket | 1 |
| 104 | bottom lock bolt bracket | 1 |
| 105 | CEN boltwork pre-assembled | 1 |
| 106 | pressure spring | 3 |
| 107 | relocker pin | 3 |
| 108 | bolt switch | 3 |
| 109 | relocker cover plate | 2 |
| 110 | handlebar | 1 |
| 111 | cheese head screw | 7 |
| 112 | pan head screw | 4 |
| 113 | pan head screw | 3 |
| 114 | washer | 4 |
| 115 | hexagonal nut | 2 |
| 116 | washer | 1 |
| 117 | pan head screw | 4 |

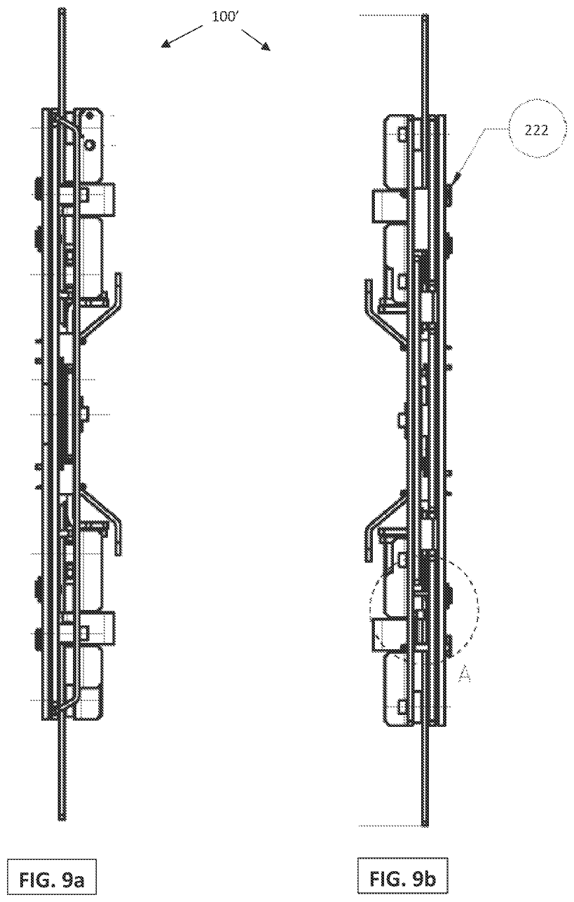

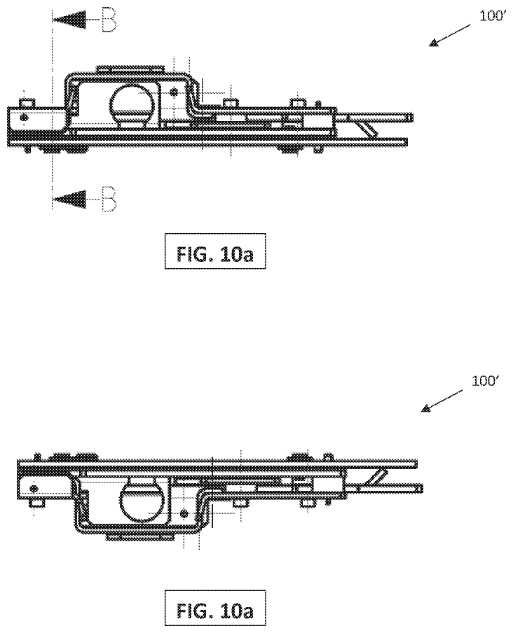

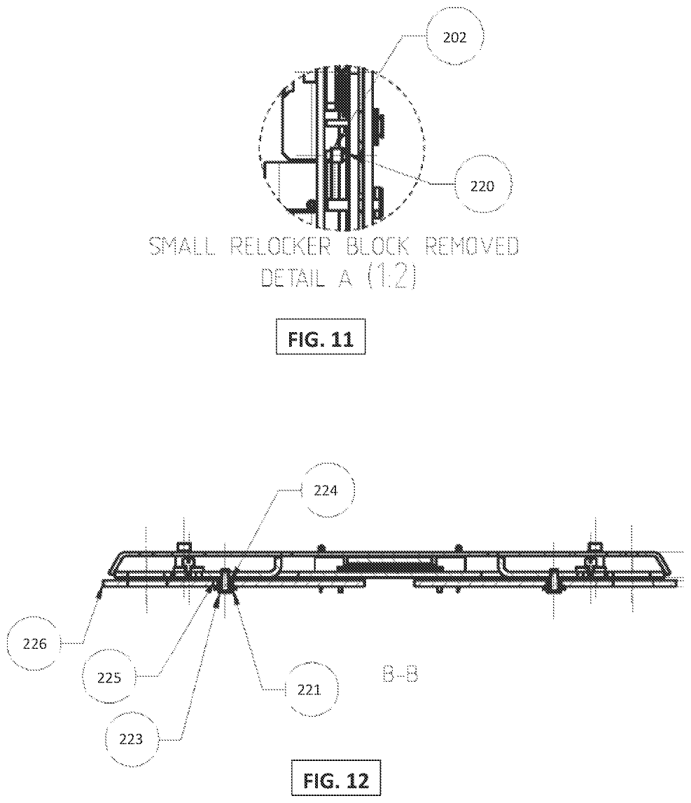

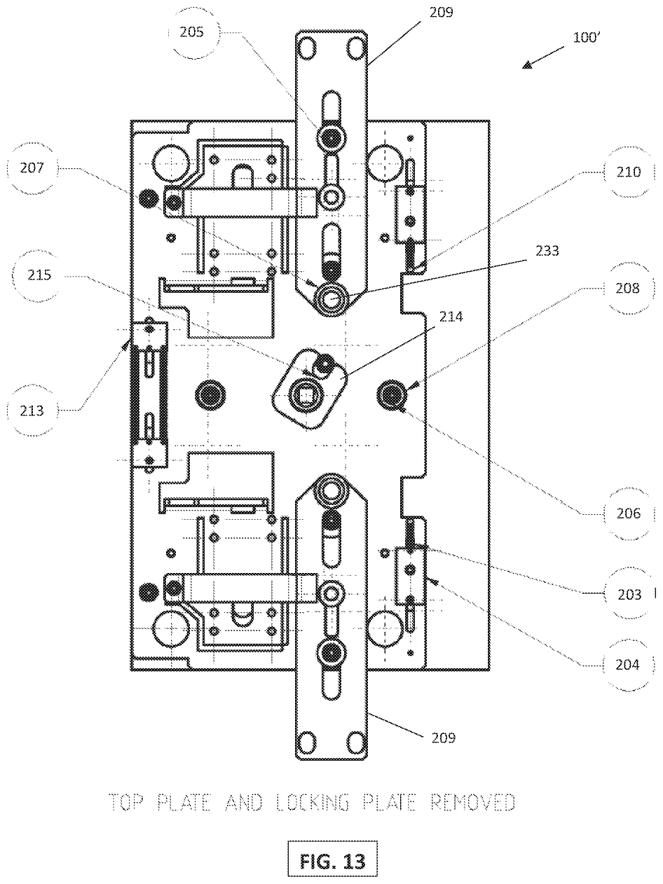

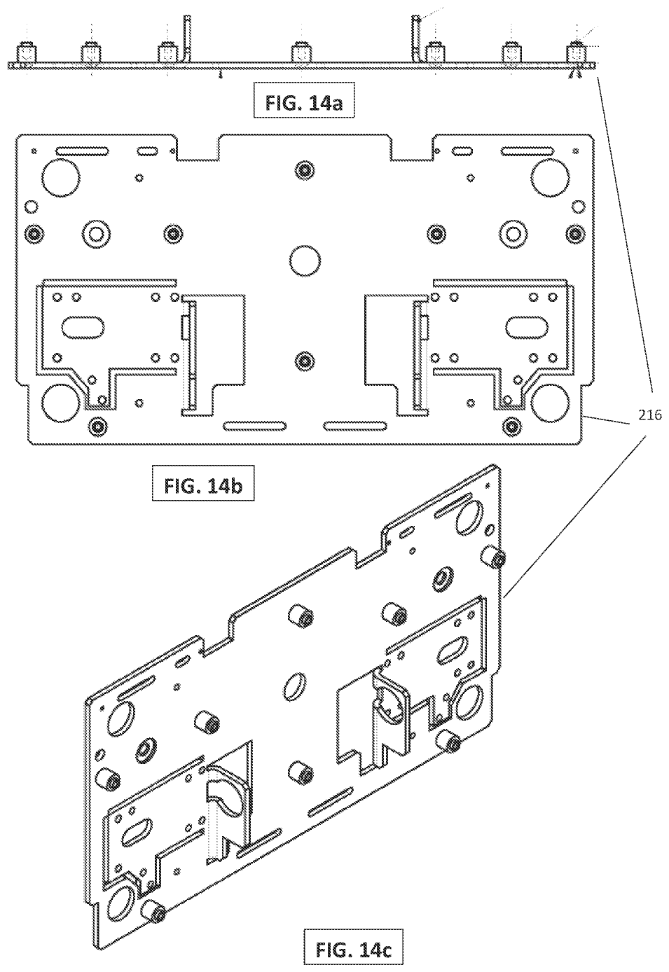

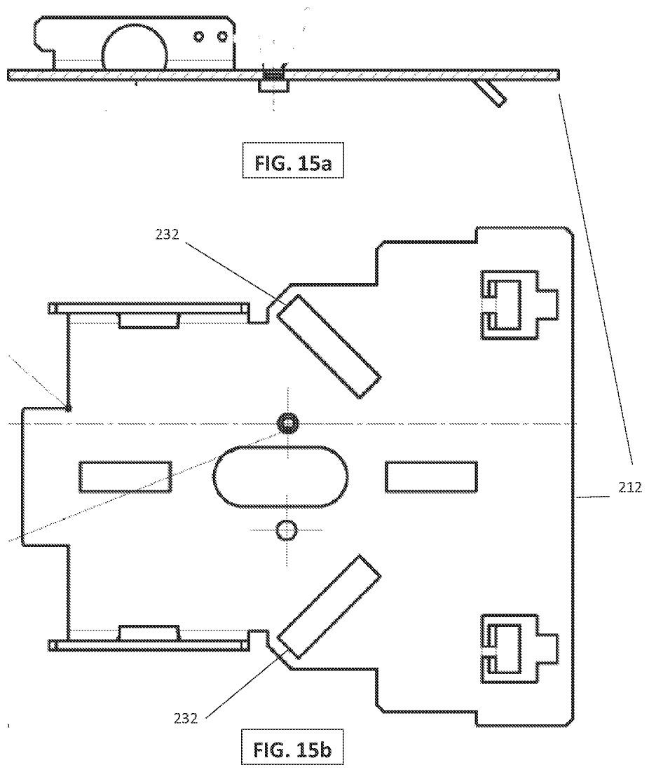

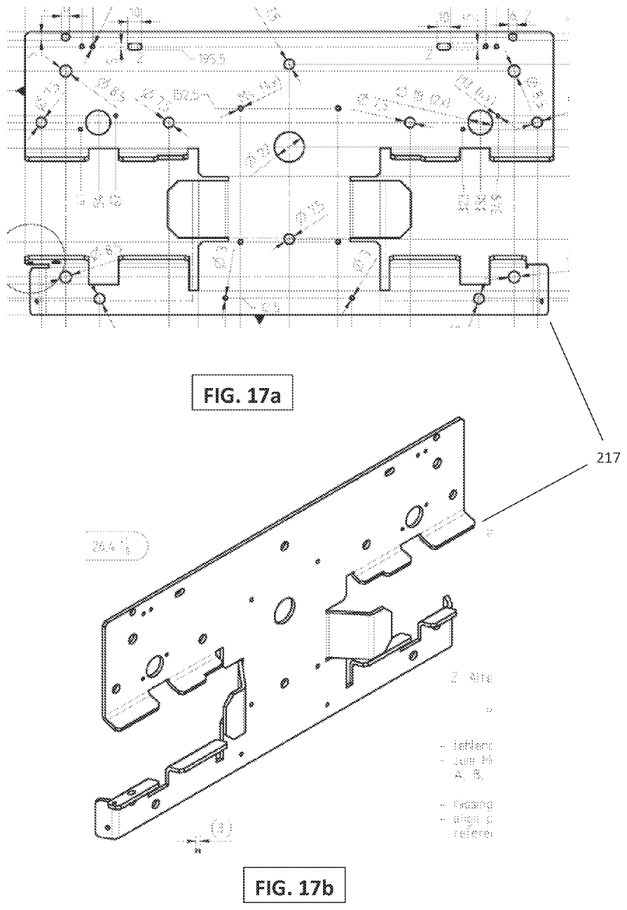

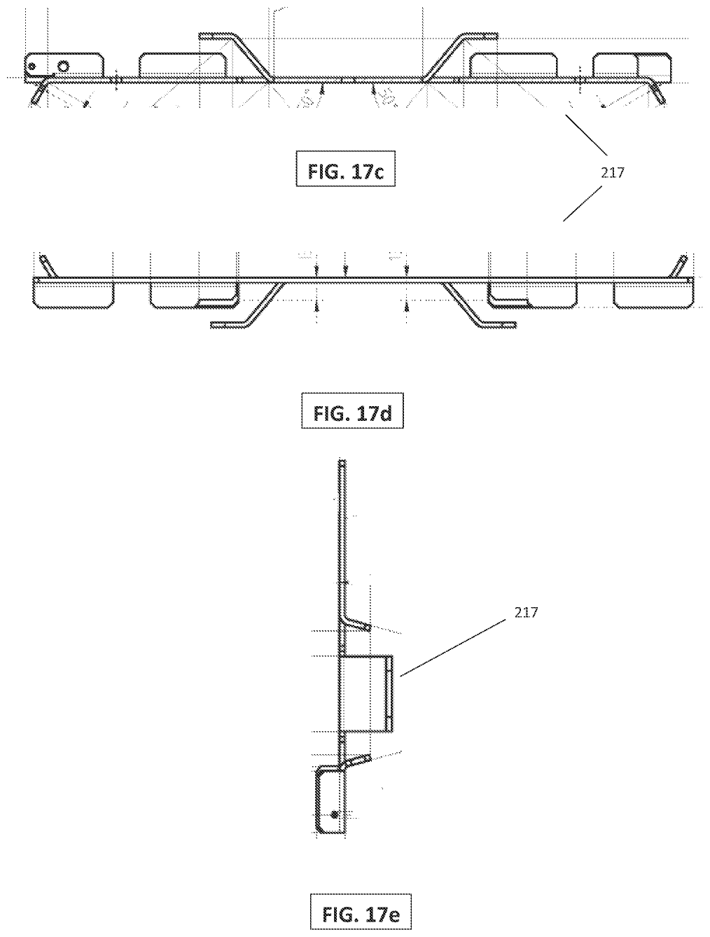

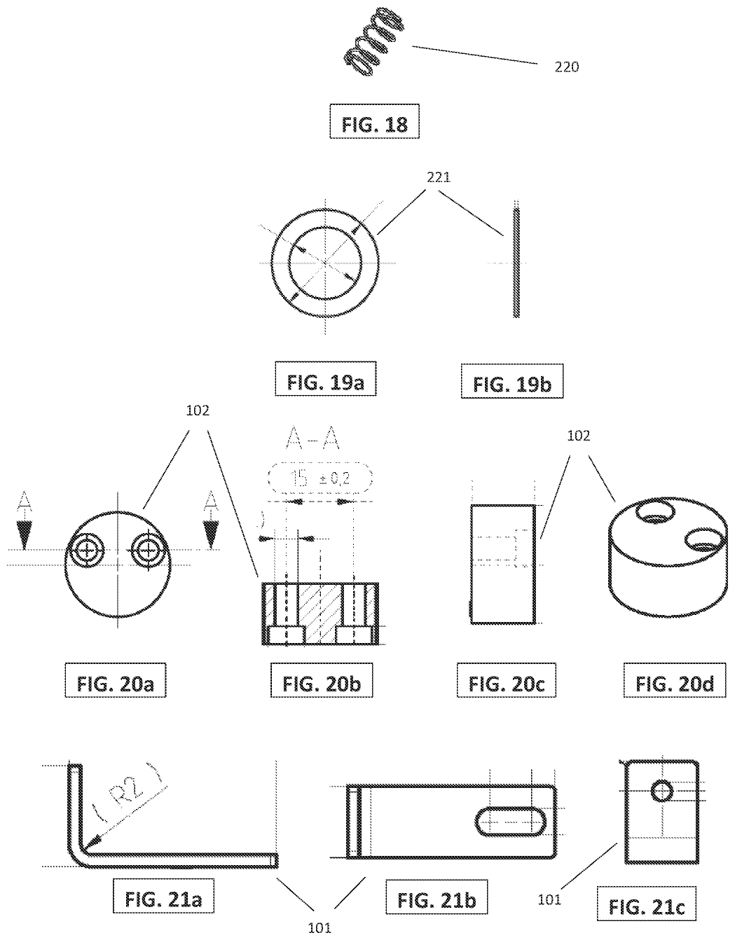

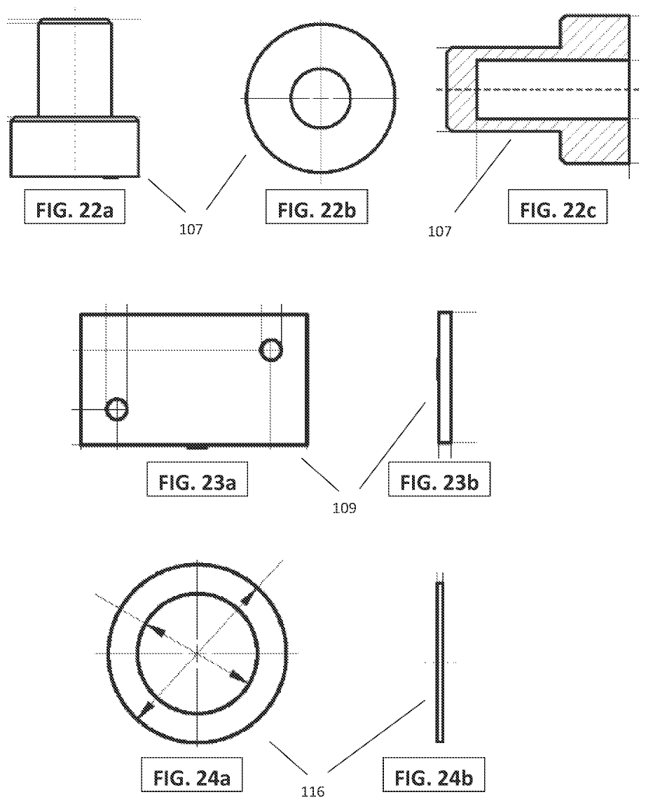

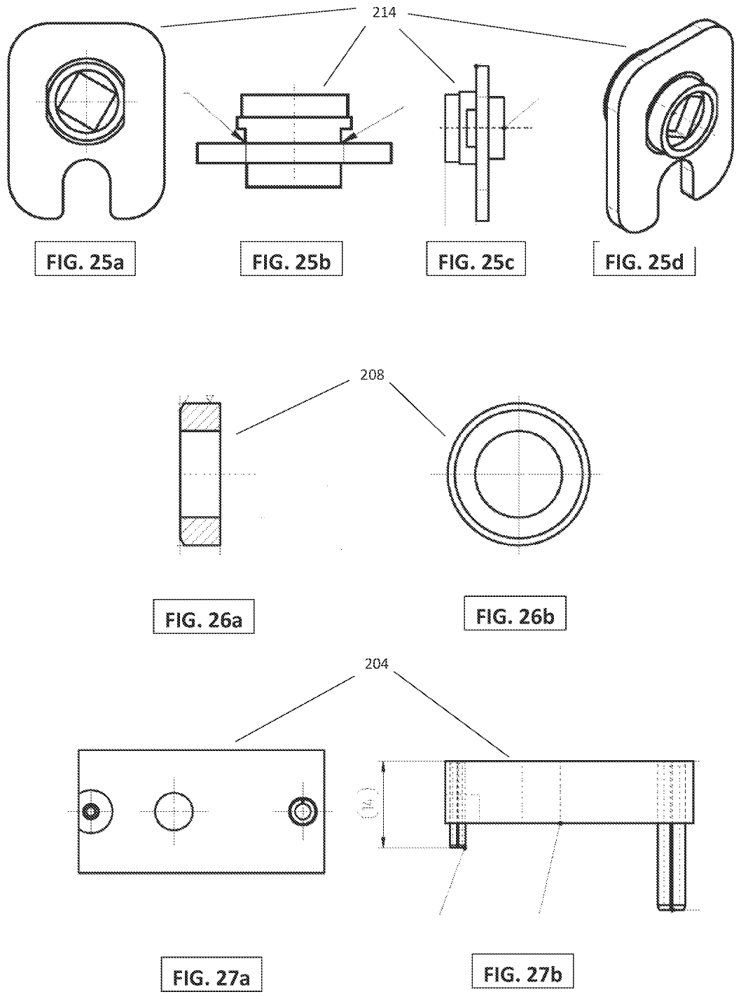

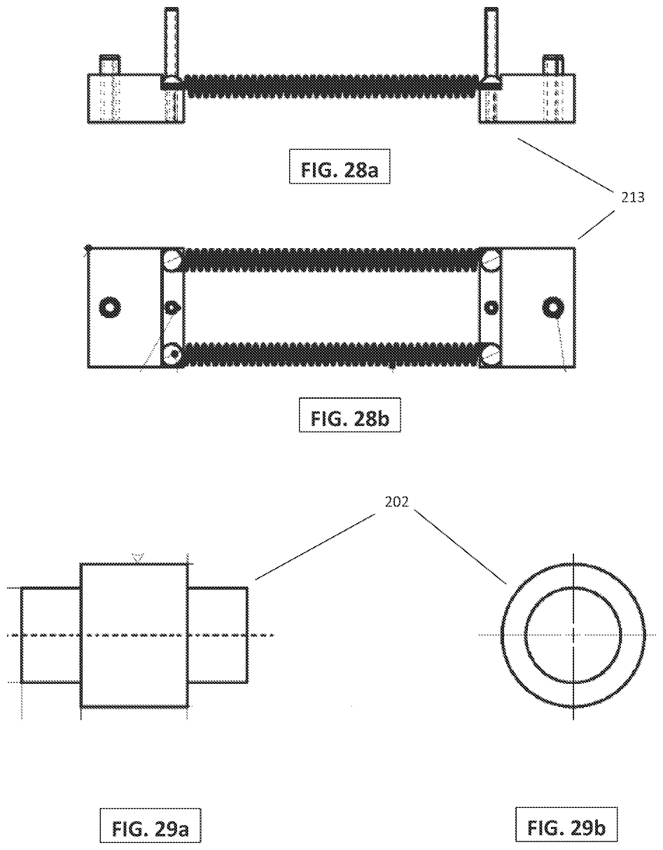

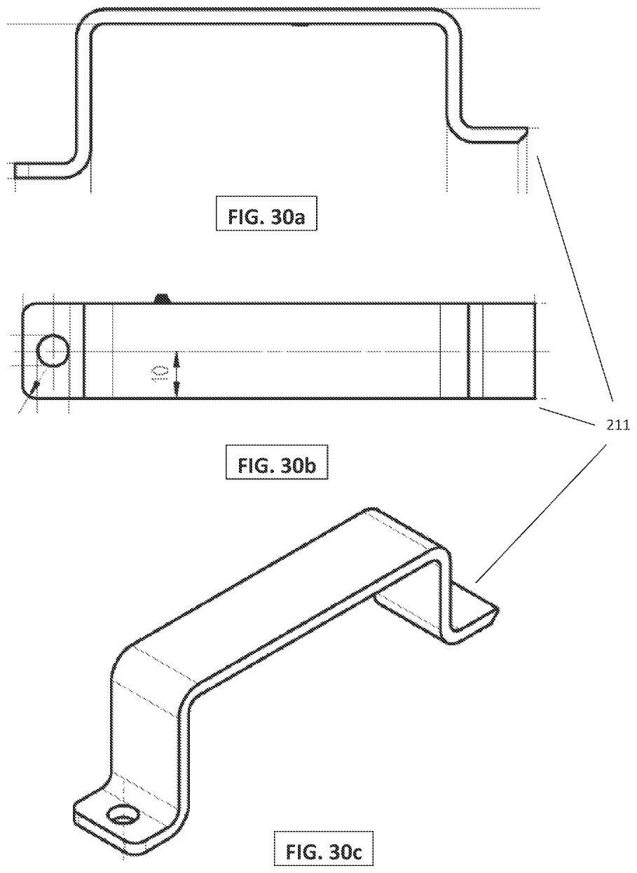

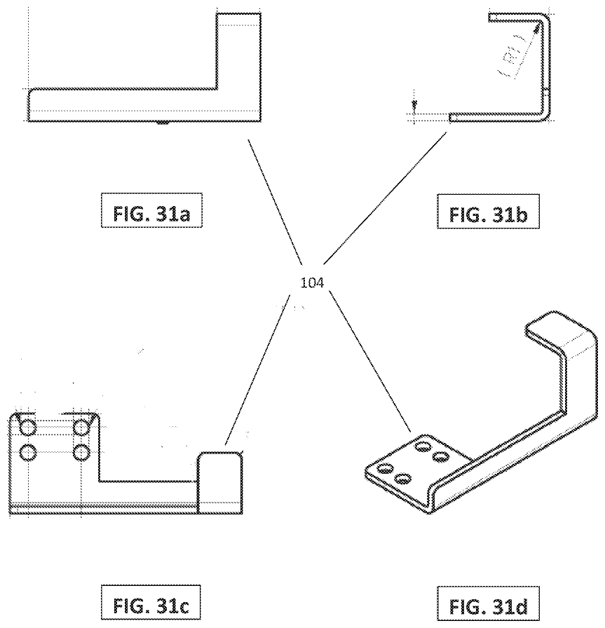

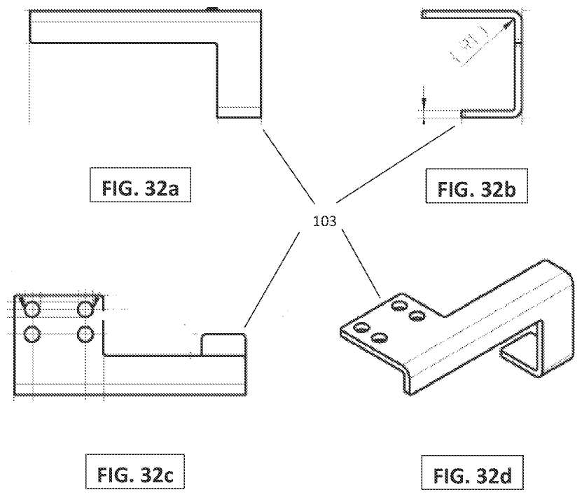

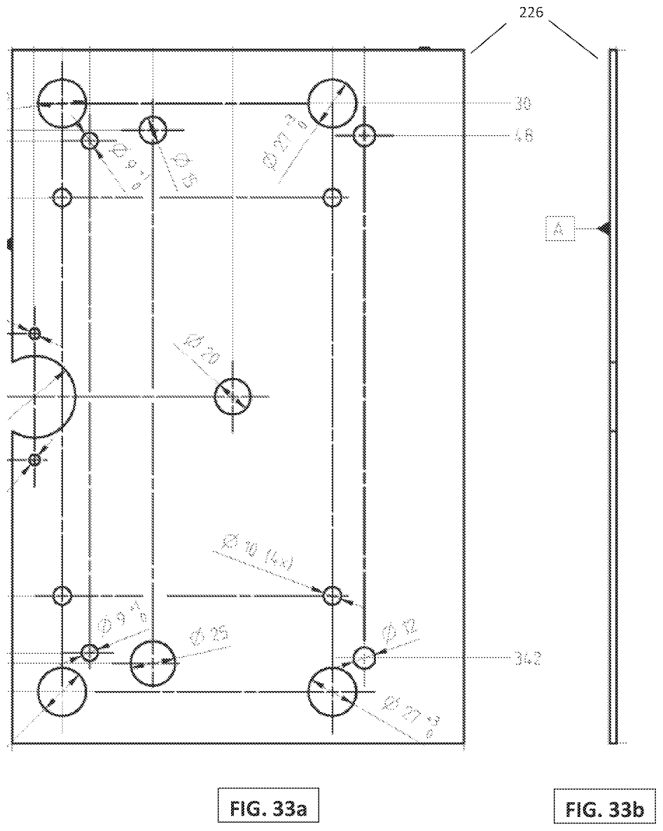

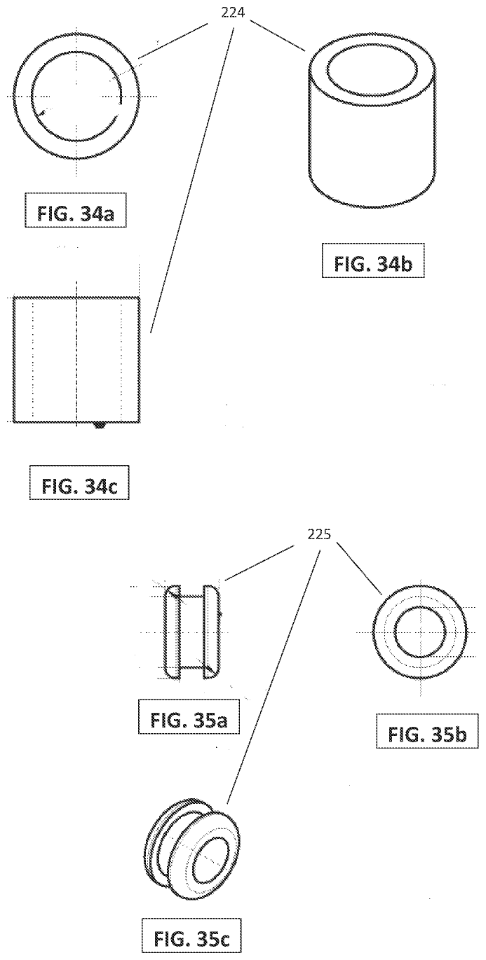

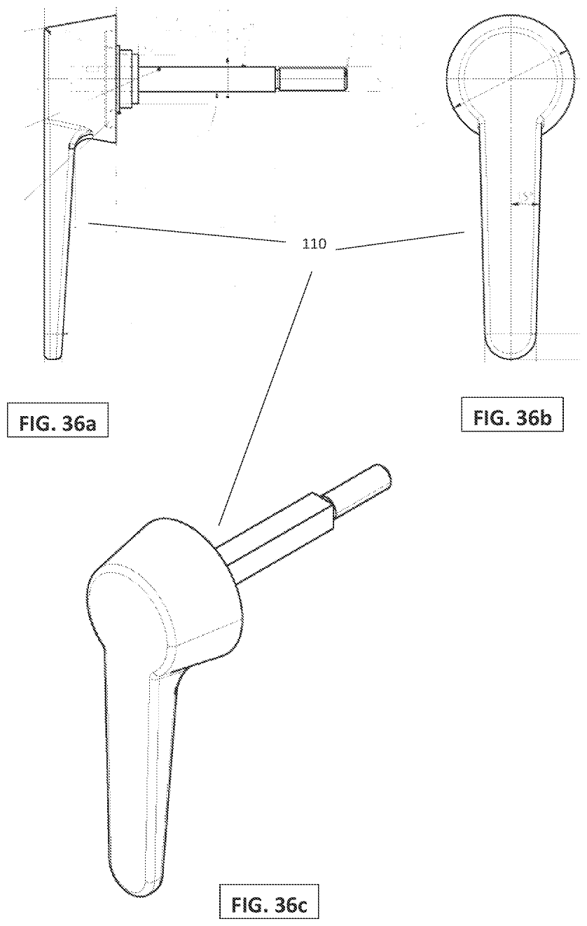

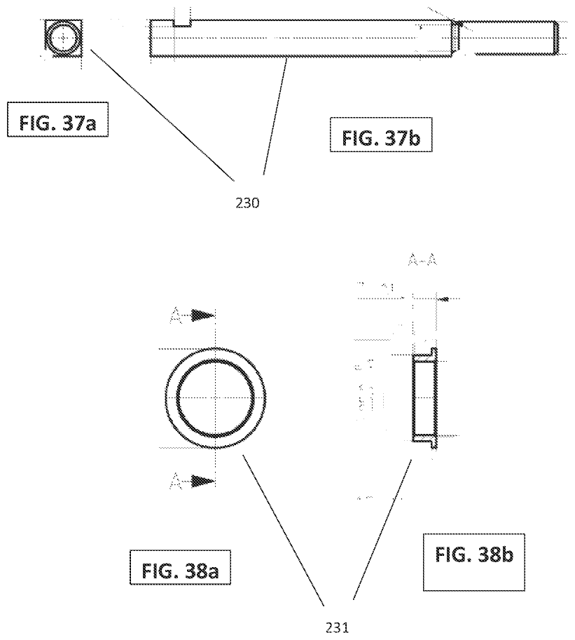

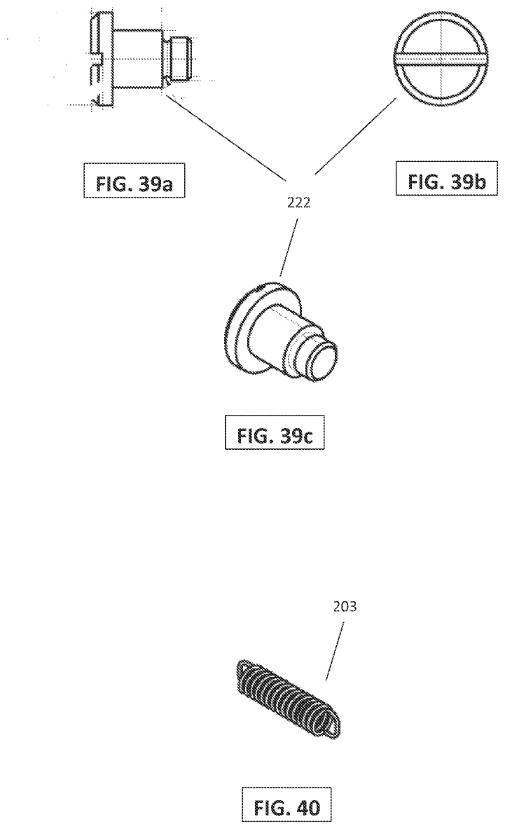

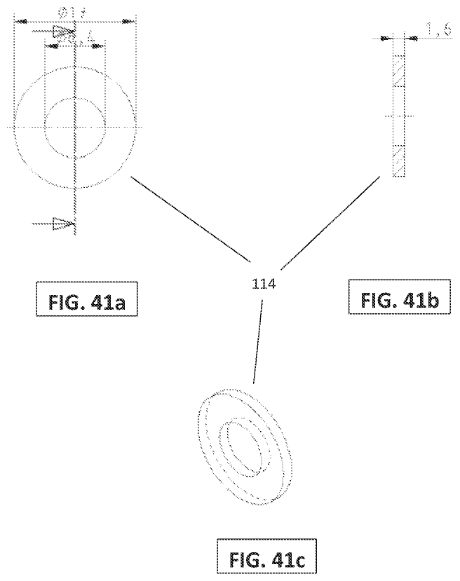

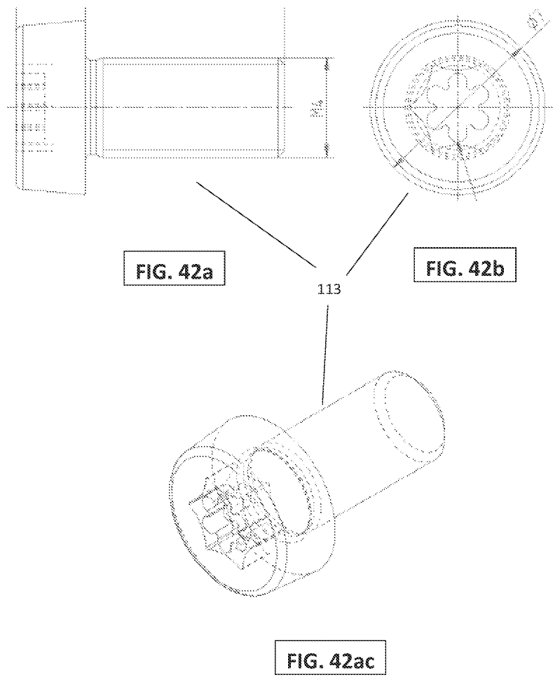

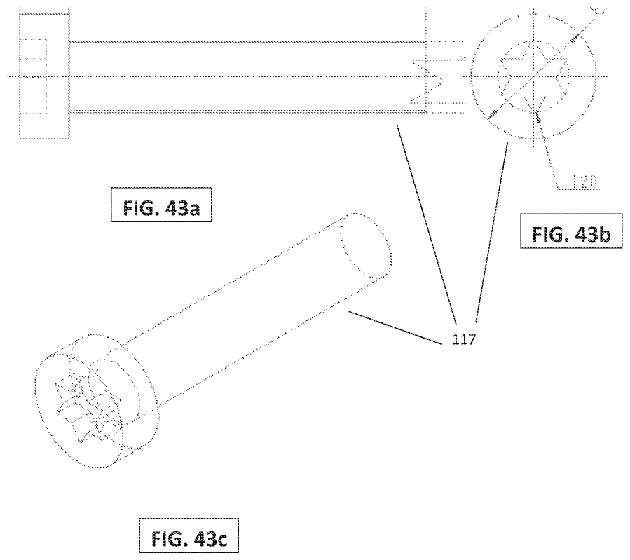

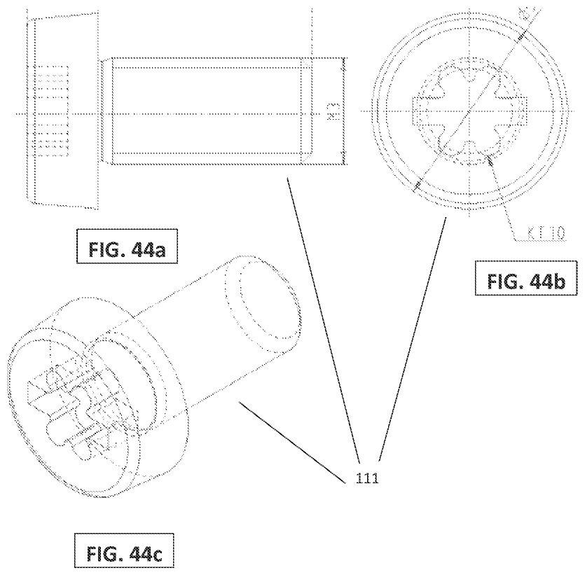

Components in the table below can be used in the embodiment of bolt mechanism 100′ shown in FIG. 8 through FIG. 41. Some or all of the components in the table can be used in other embodiments.

| Number | Part | Qty |
|---|---|---|
| 201 | cotter pin | 4 |
| 202 | relocker cylinder | 2 |
| 203 | tension spring | 2 |
| 204 | relocker small | 2 |
| 205 | spacer | 2 |
| 206 | washer | 4 |
| 207 | washer | 6 |
| 208 | spacer | 2 |
| 209 | vertical bolt bar assembly | 2 |
| 210 | hammer drive screw | 2 |
| 211 | lock retaining bracket | 2 |
| 212 | locking plate assembly | 1 |
| 213 | relocker large | 1 |
| 214 | cam plate | 1 |
| 215 | washer | 1 |
| 216 | base plate | 1 |
| 217 | cover plate | 1 |
| 218 | lockwasher | 10 |
| 219 | cylinder head screw | 10 |
| 220 | pressure spring | 2 |
| 221 | washer | 4 |
| 222 | pan head screw with slot | 2 |
| 223 | DIRAK counter sunk screw | 4 |
| 224 | glass plate bushing | 4 |
| 225 | rubber bushing | 4 |
| 226 | glass plate | 1 |

FIG. 9b is a side view of the embodiment seen in FIG. 8, and shows the position of pan head screw 222. Pan head screw 222 can be used to fasten base plate 216 to other components inside bolt mechanism 100 and can extend through holes in glass plate 226.

While principles and modes of operation have been explained and illustrated with regard to particular embodiments, it must be understood, however, that this may be practiced otherwise than as specifically explained and illustrated without departing from its spirit or scope.

What is claimed is:

1. A mechanism for actuating a boltwork sensing switch in an Automated Transaction Machine (ATM) comprising:
a switch in communication with a control unit of an ATM;
a bracket having a proximal end and a distal end; and
linear actuators rigidly affixed to the proximal end of the bracket, and operable to linearly move the bracket in synchronized linear movement with the actuators such that the distal end of the bracket will come into contact with the switch, causing the switch to change its binary status from either open to closed or closed to open, and send a signal from the switch to the control unit which indicates whether a main bolt of a safe door is open or closed.

2. A bolt mechanism for a safe of an Automated Transaction Machine comprising:
a base plate;
a cover plate fixedly attached to said base plate;
a first electric switch mounted on said cover plate, said first electric switch having a first actuator arm;
a locking plate assembly being displaceable along a first axis and having an open position and a closed position; and
a first lock bolt bracket operatively attached to said locking plate assembly and concurrently displaceable with said locking plate assembly along said first axis when said locking plate is displaced, and said first lock bolt bracket positioned to be able to make contact with said first actuator arm thereby changing the status of said first electric switch when said locking plate is displaced;
wherein said base plate and said cover plate are stationary relative to the displacement of said locking plate assembly when said locking plate is displaced; and
wherein displacement of said locking plate assembly from said open position to said closed position causes said first lock bolt bracket to contact said first actuator arm on said first electric switch, thereby changing the status of said first electric switch.

3. The bolt mechanism of claim 2 wherein;
displacement of said locking plate assembly from said closed position to said open position causes said first bracket to no longer contact said first actuator arm on said first electric switch, thereby changing the status of said first electric switch.

4. The bolt mechanism of claim 2, wherein said locking plate assembly is disposed between said base plate and said cover plate.

5. The bolt mechanism of claim 4 wherein at least a portion of said first lock bolt bracket extends below the surface of said cover plate.

6. The bolt mechanism of claim 4 wherein at least a portion of said locking plate assembly extends above the surface of said cover plate.

7. The bolt mechanism of claim 5 further comprising a first vertical bolt bar, wherein said first vertical bolt bar is operatively connected to said locking plate such that a displacement of said locking plate along a first axis produces a displacement of said first vertical bolt bar along a second axis, said second axis being perpendicular to said first axis.

8. The bolt mechanism of claim 2 further comprising a handlebar, wherein a rotation of said handlebar by a user results is a displacement of said locking plate assembly along said first axis.

9. The bolt mechanism of claim 2 comprising a second electric switch, wherein said second electric switch is spaced along said second axis away from said first electric switch.

10. A method for securing a safe in an ATM, comprising:
rotating a handlebar along a first rotational axis;
linearly displacing a lock bolt bracket along a first axis;
contacting a switch actuator with the lock bolt bracket;
changing a status of a switch upon effective contact of the actuator by the lock bolt bracket.

11. The method for securing a safe in an ATM of claim 10, further comprising detection of the change in status of the switch by a computing device.
